(19) United States
(12) Patent Application Publication
(10) Pub. No.: US 2007/0112981 A1
(43) Pub. Date: May 17, 2007

(54) Secure USB storage device

(75) Inventor: Edwin A. Hernandez, Coral Springs, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/274,819

(22) Filed: Nov. 15, 2005

(51) Int. Cl. G06F 13/38

(52) U.S. Cl. 710/62

(57) ABSTRACT

A removable data storage (100), for example a universal serial bus (USB) flash drive, that includes a data store (205), a user interface (110), and at least one logic device (220). In response to a correct personal identification number (PIN) being entered via the user interface, the logic device can permit access to data contained on the data store from a second device to which the removable data storage is connected. The user interface can include a display (135), such as a segmented display, and at least one button (125,130) which, when depressed, cycles through a plurality of user selectable characters (140) that are sequentially presented on the display. The user interface also can include a status indicator (115) that indicates for which of a plurality of sequential PIN character positions a character is being entered.

### BACKGROUND OF THE INVENTION

1. Field of the Invention

The present invention generally relates to storage devices and, more particularly, to removable data storages.

2. Background of the Invention

Removable data storages are commonly used to store electronic data. A few examples of such data are electronic documents, images and audio recordings. Oftentimes the data contains confidential information that, if retrieved by an unscrupulous person, could be used to embarrass or, worse yet, harm the owner of the data. Accordingly, there exists a demand for removable storage devices that provide a level of security against unauthorized retrieval of data.

One form of security that is sometimes implemented uses an application to encrypt the electronic data into a file. However, the application that created the file is then required to decrypt the file in order to access the electronic data. The electronic data contained in the file thus remains inaccessible to electronic devices which do not have access to the application. Accordingly, portability of encrypted data files is somewhat limited.

### SUMMARY OF THE INVENTION

The present invention relates to a removable data storage. The removable data storage can be, for example, a universal serial bus (USB) flash drive. The removable data storage can include a data store, a user interface, and at least one logic device. In response to a correct personal identification number (PIN) being entered via the user interface, the logic device can permit access to data contained on the data store from a second device to which the removable data storage is connected. The data store can include flash memory.

The user interface can include a display, such as a segmented display, and at least one button which, when depressed, cycles through a plurality of user selectable characters that are sequentially presented on the display. The user interface also can include a status indicator that indicates for which of a plurality of sequential PIN character positions a character is being entered. The status indicator can, for example, include a plurality of indicator lights. The removable data storage also can include a port interface, such as a USB connector, that engages a port of the second device.

The logic device can compare the PIN to an encrypted PIN, after the encrypted PIN has been decrypted, to determine whether the PIN correlates to the encrypted PIN. For example, a decryption algorithm can be used to decrypt the encrypted PIN using a public key. The data storage can include read only memory (ROM) to which the decryption algorithm can be stored. The encrypted PIN can be stored to the data store.

The present invention also relates to a method for securing a removable data storage. The method can include receiving a PIN entered directly into a user interface of the removable data storage. For example, a user input can be received to select a character presented on a display of the removable data storage. The received PIN can be compared to an encrypted PIN stored on the removable data storage. The encrypted PIN can be decrypted with a public key. A second device to which the removable data storage is connected can be permitted access to data stored on the removable data storage in response to the received PIN matching the encrypted PIN. Access to the data stored on the removable data storage can be blocked in response to the received PIN not matching the encrypted PIN.

### BRIEF DESCRIPTION OF THE DRAWINGS

Preferred embodiments of the present invention will be described below in more detail, with reference to the accompanying drawings, in which:

FIG. 1 depicts a removable data storage that is useful for understanding the present invention.

FIG. 2 depicts a block diagram of the removable data storage of FIG. 1.

FIG. 3 is flowchart that is useful for understanding the present invention.

FIG. 4 is another flowchart that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a secure removable data storage. In contrast to prior methods of securing data, the present invention does not require execution of an external application to access secured data. Instead, the removable data storage of the present invention includes a user interface into which a PIN can be entered to unlock the data. Once unlocked, the data can be accessed by a device, such as a computer, to which the removable data storage is connected.

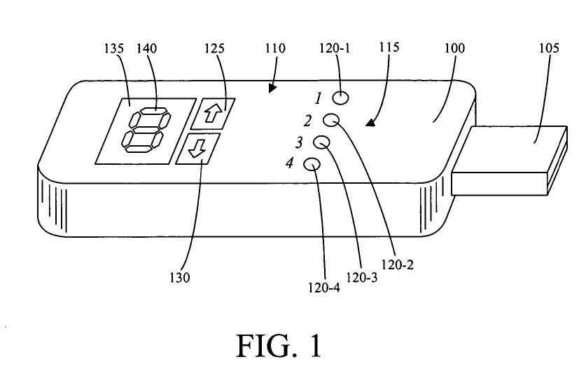

FIG. 1 depicts a removable data storage (hereinafter “data storage”) 100 that is useful for understanding the present invention. The data storage 100 can be, for instance, a flash drive. The data storage 100 can include a port interface 105 that can be used to connect the data storage 100 to a port of a second system, such as a computer port. In an arrangement in which the data storage 100 is a universal serial bus (USB) flash drive, the port interface 105 can comprise a USB connector. Nonetheless, the invention is not limited in this regard and the data storage 100 can be configured to interface with other types of ports. For example, the port interface 105 can comprise an IEEE-1394(FireWire) connector, a serial port connector, a parallel port connector, or any other connector that can be used to connect the data storage 100 to the second system.

The data storage 100 also can include a user interface 110. The user interface 110 can be used to receive user inputs to unlock the data storage 100 and to indicate the status of the data storage 100. For example, the user interface 110 can include a status indicator 115. In one arrangement, the status indicator 115 can comprise one or more indicator lights 120-1, 120-2, 120-3, 120-4, such as light emitting diodes (LEDs), which turn on, turn off, flash, or emit particular colors of light indicating the status storage device 100. For instance, the indicator lights 120 can remain off when the storage device 100 is not connected to a second device. If the storage device is connected to the second device, but is locked, the indicator lights 120 can emit a particular color, such as red, to indicate the locked status. In another arrangement, a locked status can be indicated when one or more of the indicator lights 120, for example indicator light 120-1, are illuminated while the remaining indicator lights 120 remain off. Still, a locked status can be indicated by the status indicator 115 in a myriad of other ways and the invention is not limited in this regard.

In an arrangement in which a single indicator light 120 is provided, the indicator light can be flashed at different frequencies to indicate different messages. For instance, the indicator light 120 can flash at a first frequency to indicate that the data storage 100 is ready to receive a first PIN character, flash at a second frequency to indicate that the data storage 100 is ready to receive a second PIN character, flash at a third frequency to indicate that the data storage 100 is ready to receive a third PIN character, and so on.

In an arrangement in which a plurality of indicator lights 120 are provided, each indicator light can correspond to a particular personal identification number (PIN) character. For example, indicator light 120-1 can flash to indicate that the data storage 100 is ready to receive a first PIN character, indicator light 120-2 can flash to indicate that the data storage 100 is ready to receive a second PIN character, indicator light 120-3 can flash to indicate that the data storage 100 is ready to receive a third PIN character, and indicator light 120-4 can flash to indicate that the data storage 100 is ready to receive a fourth PIN character. If the PIN comprises more characters, additional indicator lights can be associated with such characters, or combinations of the indicator lights 120 can be used to indicate that the data storage 100 is ready to receive such characters.

In another arrangement, the status indicator 115 can comprise a segmented display to indicate the various messages described herein. For example, the segmented display can present one or more characters that prompt the user to enter the various PIN characters. Still, the status indicator can be implemented any other manner and the invention is not limited in this regard.

The user interface also can include buttons 125, 130 to receive user inputs, for example to enter the PIN that unlocks the data storage 100. In one arrangement, user inputs can be received via the buttons 125, 130 to cycle through the user selectable characters until a desired character 140 is presented on a display 135. The display 135 can be, for example, a segmented display or a pixelated display. Such displays are known the skilled artisan. In one arrangement, the display 135 and status indicator 115 both can be presented by a single display, such as a liquid crystal display (LCD). The LCD can be a segmented display, a pixelated display, or any other type of LCD display.

The character 140 that is presented on the display 135 can be automatically selected after the expiration of a defined period of time since a last user input was received. In another arrangement, the character 140 can be selected by simultaneously depressing both buttons 125, 130. Still, other methods can be implemented to select the character 140.

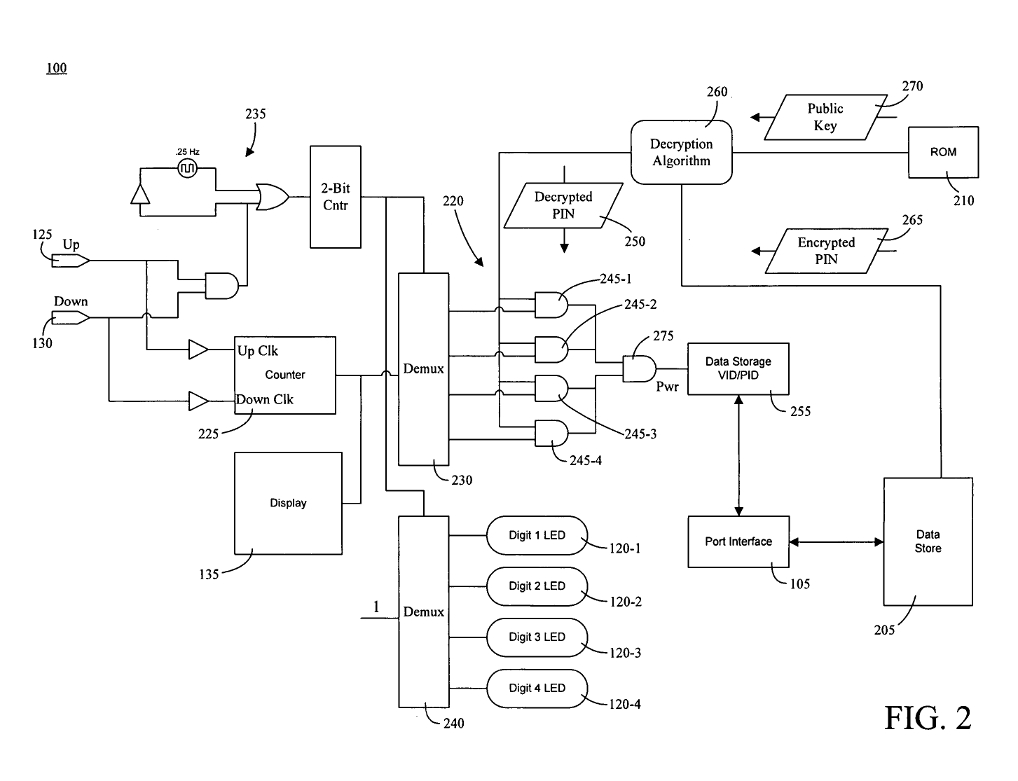

FIG. 2 depicts a block diagram of the data storage 100. In addition to the port interface 105, the indicator lights 120, the buttons 125, 130 and the display 135 previously discussed, the data storage 100 can include a data store 205, such as flash memory, a read only memory (ROM) 210, a decryption algorithm 260 and logic devices 220.

In operation, user inputs entered via the buttons 125, 130 can be entered into a counter 225. The counter 225 can select a next sequential character for each button push, either a previous or lower character if the down button 130 is pushed, or a next or higher character if the up button 125 is pushed. The character currently selected by the counter 225 can be forwarded to a first demultiplexer 230 and to the display 135 to be presented. A timing circuit 235 can be used to signal to the first demultiplexer 230 to choose the current character as the user selected character after a time-out period. The timing circuit 235 also can signal a second demultiplexer 240 to flash (or illuminate) a next LED. For example, prior to the first user selection, the first LED 120-1 can be flashed. After the first user selection, the second LED 120-2 can be flashed to indicate to the user that the data storage 100 is ready to receive a next character selection from the user.

Each user character selection can be stored in the first demultiplexer 230 until a required number of user character selections have been made. After the required number of characters have been selected by the user, the first demultiplexer 230 can forward each of the characters to a respective logic device 245-1, 245-2, 245-3, 245-4. Each of the logic devices 245 can compare its respective user selected character to a character in a corresponding position within a decrypted PIN 250. In an alternate arrangement, the decrypted PIN 250 can be a binary or hexadecimal value, and the entered characters can be converted to a binary or hexadecimal value by the first demultiplexer 230 prior to the comparison. In this arrangement, the binary or hexadecimal values can be compared.

If each of the user selected characters match their corresponding PIN characters (or the binary or hexadecimal values match), a logic device 275 can apply power to the data storage product identification (PID)/vendor identification (VID) module 255, which enables the data storage 100 to be recognized by a second device (not shown) to which the data storage 100 is connected via the port interface 105. For example, the PID/VID module 255 can send a PID and/or VID to an operating system of the second device. The second device then can access the data store 205.

The decryption algorithm 260 can be used to decrypt an encrypted PIN 265 using a public key 270 to generate the decrypted PIN 250. The encrypted PIN 265 can be generated using a private key and stored to the data store 205. The encrypted PIN can be stored as a standard entry, a text file, or stored in any other suitable form. In one arrangement, the encrypted PIN can be stored in the data storage's file system, for instance in a FAT32 file system, NTFS file system, or any other file system used by the data storage. Alternatively, the encrypted PIN can be stored in another data store (not shown) within the data storage that is not mapped as available file system memory. This arrangement can provide enhanced security while still enabling the encrypted PIN to be changed by a secure application. For example, the secure application can generate a new encrypted PIN to replace the existing encrypted PIN 265 when the PIN is changed. Of course, the existing PIN would be required to access the data storage before 100 the new encrypted PIN can be stored.

The public key 270 and decryption algorithm 260 can be stored to the ROM 210 as embedded firmware during manufacture of the data storage 100. Such embedding can enhance security by reducing the risk of such files being overwritten or deleted. In another arrangement, however, the decryption algorithm 260 can be stored to the data store 205 to allow for periodic updates.

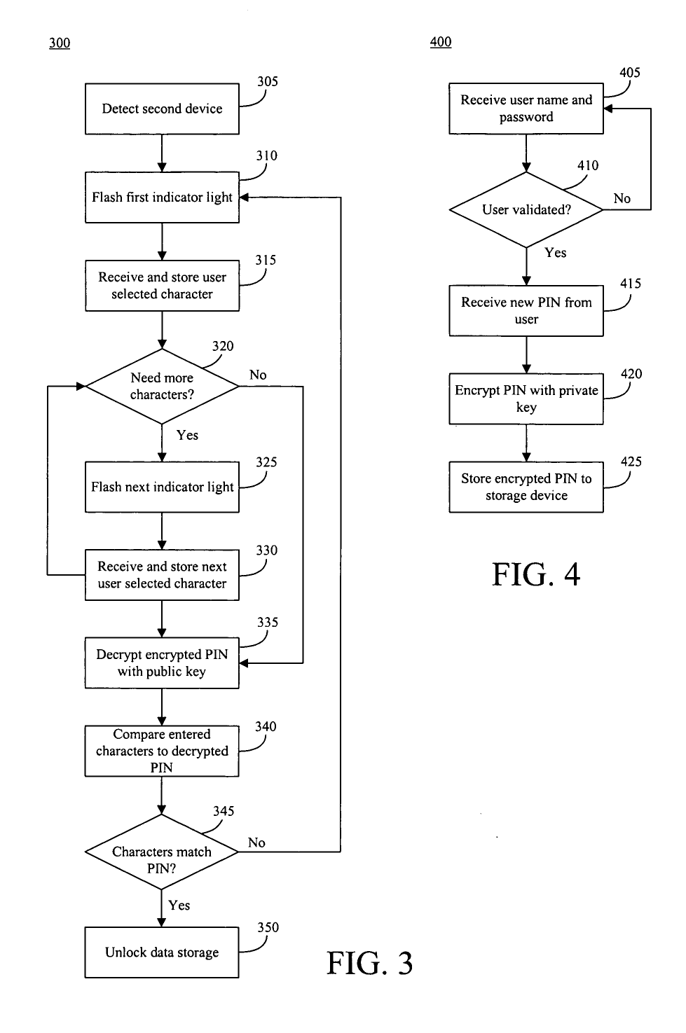

FIG. 3 is flowchart that presents a method 300 for unlocking the data storage. Beginning at step 305, the data storage can detect that it has been connected to a second device, for instance via a USB port. At step 310, a first indicator light can be flashed (or illuminated). At step 315 a user selected character can be received and stored. Referring to decision box 320, if more characters are needed, for instance to form a complete PIN, a next indicator light can be flashed, as shown in step 330. Continuing to step 335, a next user selected character can be received and stored.

Once the required number of characters have been entered, the process can proceed to step 340 where the entered characters can be compared to a decrypted PIN. As noted, the characters can be compared on a character by character basis, or the entire series of entered characters can be converted to a binary or hexadecimal value and compared to a decrypted PIN that is binary or hexadecimal. Referring to decision box 345 and step 350, if the user selected characters match the PIN, the data storage can be unlocked, for example by applying power to a data storage PID/VID module. If the characters do not match, the process can return to step 310 where the first indicator light is again illuminated. The data storage then can receive a new set of user selected characters.

FIG. 4 is flowchart that presents a method 400 for storing or updating an encrypted PIN to the data storage. The method 400 can begin in a state in which a user updating the data storage has accessed a PIN encryption application, for example on a local computer or over the Internet. At step 405 the PIN encryption application can receive a user name and password to validate the user. Referring to decision box 410, if the user validation fails, the user can again be prompted to enter the user name and password, as shown in step 405. If the user validation is successful, the user can be prompted to enter a new PIN, and the PIN can be received by the application, as shown in step 415. Proceeding to step 420, the application can encrypt the PIN with a private key. At step 425, the application can store the encrypted PIN to the storage device.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A removable data storage, comprising:
a data store;
a user interface; and
at least one logic device that, responsive to a correct personal identification number (PIN) being entered via the user interface, permits access to data contained on the data store from a second device to which the removable data storage is connected.

2. The removable data storage of claim 1, wherein the data store comprises flash memory.

3. The removable data storage of claim 2, wherein the removable data storage is a universal serial bus (USB) flash drive.

4. The removable data storage of claim 1, wherein the user interface comprises a segmented display.

5. The removable data storage of claim 4, wherein the user interface further comprises at least one button which, when depressed, cycles through a plurality of user selectable characters that are sequentially presented on the segmented display.

6. The removable data storage of claim 4, wherein the user interface further comprises a status indicator that indicates for which of a plurality of sequential PIN character positions that a character is being entered.

7. The removable data storage of claim 6, wherein the status indicator comprises a plurality of indicator lights.

8. The removable data storage of claim 1, further comprising a port interface that engages a port of the second device.

9. The removable data storage of claim 8, wherein the port interface is a USB connector.

10. The removable data storage of claim 1, wherein the logic device compares the PIN to an encrypted PIN, after the encrypted PIN has been decrypted, to determine whether the PIN correlates to the encrypted PIN.

11. The removable data storage of claim 10, wherein the encrypted PIN is stored to the data store.

12. The removable data storage of claim 1, further comprising read only memory (ROM) to which a decryption algorithm is stored, the decryption algorithm decrypting the encrypted PIN using a public key.

13. A USB flash drive, comprising:
flash memory;
a user interface; ROM; and
at least one logic device that, responsive to a correct PIN being entered via the user interface, permits access to data contained on the flash memory from a second device to which the USB flash drive is connected.

14. The removable data storage of claim 13, wherein the user interface comprises a segmented display.

15. The removable data storage of claim 13, wherein the user interface comprises at least one button which, when depressed, cycles through a plurality of user selectable characters that are sequentially presented on the segmented display.

16. The removable data storage of claim 13, wherein the interface comprises a status indicator that indicates for which of a plurality of sequential PIN character positions that a character is being entered.

17. The removable data storage of claim 16, wherein the status indicator comprises a plurality of indicator lights.

18. A method for securing a removable data storage, comprising:
receiving a PIN entered directly into a user interface of the removable data storage;
comparing the received PIN to an encrypted PIN stored on the removable data storage;
responsive to the received PIN matching the encrypted PIN, permitting data stored on the removable data storage to be accessed by a second device to which the removable data storage is connected; and
responsive to the received PIN not matching the encrypted PIN, blocking access to the data stored on the removable data storage.

19. The method according to claim 18, wherein comparing the received PIN to the encrypted PIN comprises decrypting the encrypted PIN with a public key.

20. The method according to claim 18, wherein receiving the PIN comprises receiving a user input to select a character presented on a display of the removable data storage.
